(19) United States
(12) Patent Application Publication
(10) Pub. No.: US 2003/0066094 A1
(43) Pub. Date: Apr. 3, 2003

(54) Robust method for recovering a program time base in MPEG-2 transport streams and achieving audio/video sychronization

(75) Inventors: Auke Sjoerd van der Schaar, Ossining, NY (US); Arno Glim, Sunnyvale, NY (US); Murali Mani, Chappaqua, NY (US); Ramanathan Meenakshisundaram, Ossining, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V., Eindhoven (NL)

(21) Appl. No.: 09/967,877

(22) Filed: Sep. 29, 2001

(51) Int. Cl. H04N 7/16

(52) U.S. Cl. 725/151

(57) ABSTRACT

An internal system time clock within an MPEG-2 decoder is synchronized in frequency and optionally in phase, but not in value, to program clock reference time stamps within a received MPEG-2 transport stream. A demultiplexer separating audio and video packets from the transport stream modifies the decoding and presentation time stamps within such packets by at least an offset between the program clock reference time stamp values and the internal system time clock time before forwarding the packets to the audio and video decoders. Discontinuities in the program clock reference time stamp sequence automatically result in a change in the offset, such that the internal system time clock continues to increase monotonically and decoding and presentation time stamps within the packets are not suddenly invalidated.

### TECHNICAL FIELD OF THE INVENTION

The present invention is directed, in general, to synchronizing decoding of digital audio/video data packets from a broadcast stream and, more specifically, to handling time-base sequence discontinuities in a reference signal employed to schedule decoding and presentation of content within such audio/video data packets.

### BACKGROUND OF THE INVENTION

The Moving Picture Experts Group phase 2 (MPEG-2) standard is a digital audio/video (A/V) compression standard employed in a variety of audio/video distribution systems including, for example, Digital Satellite System (DSS) broadcasting. The MPEG-2 transport standard, ISO 13818-1, requires the broadcaster to transmit a program clock reference (PCR) time stamp within the multiplexed audio and video packet stream at periodic intervals. This program clock reference time stamp, referred to as a system clock reference (SCR) in the DSS program stream, bears a strict relationship to the system time clock (STC) within the MPEG-2 encoder generating the broadcast stream, and therefore may be employed to replicate the encoder's system time clock. Additionally, each audio and video packet multiplexed into the MPEG-2 broadcast stream contains a decoding time stamp (DTS) and a presentation time stamp (PTS), which identify the times, relative to the program clock reference, at which the packet must be decoded and presented for display, respectively.

Presentation of audio and video content decoded from separate packets within the MPEG-2 broadcast stream is synchronized using the decoding and presentation time stamps within the relevant packets. MPEG-2 decoders must therefore recover and maintain an internal replica of the encoder system time clock based on the program clock reference time stamps within the broadcast stream, and track long-term frequency changes in the encoder's system time clock by adjusting the internal system time clock. Currently, such encoder system time clock recovery and tracking is typically accomplished utilizing an internal hardware clock locked in frequency and value to the recovered program clock reference time stamps using phase locked loops (PLLs) within the audio and video decoders.

Time base discontinuities may occur in the sequence of program clock references for the MPEG-2 transport stream which are presented to the decoder due, for instance, to commercial break-in or program (channel) changes by the user. Therefore the MPEG-2 decoder should also be robust against time base discontinuities and missing discontinuity indicators, and should lock to the frequency/timebase of a new program as quickly as possible after a program change.

A program clock reference time stamp discontinuity in the MPEG-2 broadcast stream will result, for example, in a corresponding jump by the decoder's internal system time clock, typically resulting in a large difference between the decoder's internal system time clock time and the decoding and presentation time stamps for packets within the decoder's pipeline (which relate to the “old” program clock reference sequence values). If, upon detecting such a large offset, the decoder simply discards any packets having large discrepancies between decoding and presentation time stamps from the internal system time clock time, irregular jumps or breaks may result in the audio/video presentation. Robust MPEG-2 decoders must therefore have built-in heuristics to deal with program clock reference sequence discontinuities.

The problems arising from such program clock reference discontinuities are exacerbated in software-based MPEG-2 decoders, where the delay in the decoder pipeline is stochastic since the processor must sequentially service the demultiplexer separating the audio and video packets from the broadcast stream and the audio and video decoders, each in turn in a repeating loop. Therefore, even in the absence of discontinuities, the audio and video decoders are not guaranteed to receive content data in a fixed time interval after such data arrives at the decoder input.

There is, therefore, a need in the art for a system of synchronizing presentation of audio and video content decoded from an MPEG-2 broadcast stream which tolerates discontinuities in the program clock reference time stamp value sequence without heuristics for handling such discontinuities or introducing breaks or pauses in the audio/video presentation.

### SUMMARY OF THE INVENTION

To address the above-discussed deficiencies of the prior art, it is a primary object of the present invention to provide, for use in an MPEG-2 decoder, an internal system time clock synchronized in frequency and optionally in phase, but not in value, to program clock reference time stamps within a received MPEG-2 transport stream. A demultiplexer separating audio and video packets from the transport stream modifies the decoding and presentation time stamps within such packets by at least an offset between the program clock reference time stamp values and the internal system time clock time before forwarding the packets to the audio and video decoders. Discontinuities in the program clock reference time stamp sequence automatically result in a change in the offset, such that the internal system time clock continues to increase monotonically and decoding and presentation time stamps within the packets are not suddenly invalidated.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a video system employing a robust MPEG-2 decoder according to one embodiment of the present invention;

FIG. 2 depicts in greater detail a robust MPEG-2 decoder according to one embodiment of the present invention;

FIG. 3A is a plot illustrating the relationship of the program clock reference signal, the internal system time clock, and modified presentation time stamps within a robust MPEG-2 decoder according to one embodiment of the present invention; and

FIG. 3B is a plot illustrating the internal system time clock frequency tracks a frequency reflected by program clock reference time stamps within a robust MPEG-2 decoder according to one embodiment of the present invention.

### DETAILED DESCRIPTION OF THE INVENTION

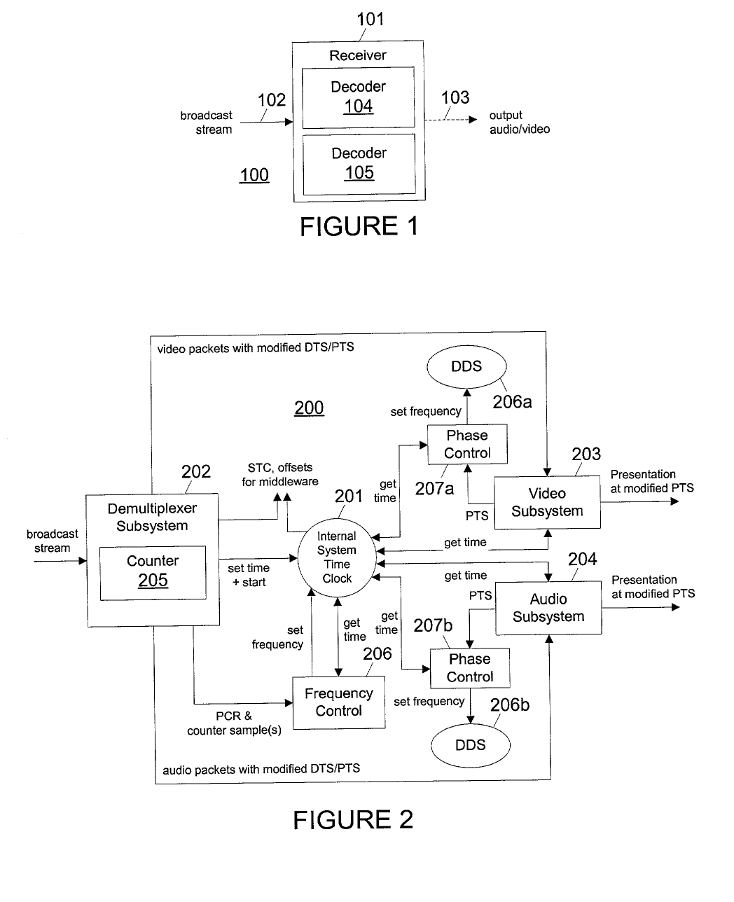

FIGS. 1 through 3A-3B, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a video system employing a robust MPEG-2 decoder according to one embodiment of the present invention. In the exemplary embodiment, the video system 100 is implemented within a video receiver 101 having an input 102 receiving an MPEG-2 broadcast stream including program clock reference signals and multiplexed audio and video packets each having decoding and presentation time stamps therein in accordance with the known art.

Video receiver 101 may be a digital television (DTV) or high definition television (HDTV) receiver, a satellite, terrestrial, or cable broadcast receiver unit for connection to a television, a set-top box for Internet access, a digital video recorder, a digital versatile disk (DVD) player, or the like, and may also include various functional components implementing some combination of such devices. Video receiver 101 may include a video display (not shown) and audio speaker(s) (also not shown), or may optionally include one or more output connections 102 for transmitting decoded audio and video signals to another device.

In the exemplary embodiment, receiver 101 is a digital video platform (DVP) integrated circuit for use in a digital television receiver or set-top box. Receiver 101 is therefore preferably capable of broadcast stream demultiplexing, digital audio and video decoding including MPEG-2 transport streams, and demodulation of all eighteen Advanced Television Systems Committee (ATSC) digital television formats and Digital Satellite System (DSS) broadcasts.

Those skilled in the art will perceive that FIG. 1 does not explicitly depict every component within a video receiver system. Only those portions of such a system that are unique to the present invention and/or required for an understanding of the structure and operation of the present invention are shown and described herein.

Receiver 101 includes one or more MPEG-2 decoders, with the exemplary embodiment including two decoders 104-105, one for connection to a television receiver and one for connection to a video cassette recorder (VCR) or digital video recorder. At least one, and preferably all, decoders within receiver 101 employ robust synchronization of audio and video packet decoding which tolerates time base discontinuities in the program clock reference time stamp sequence from the broadcast stream as described in further detail below.

FIG. 2 depicts in greater detail a robust MPEG-2 decoder according to one embodiment of the present invention. In prior art decoders where both the frequency and time value of a decoder's internal system time clock are locked to the program clock reference time stamps from the broadcast stream, time base discontinuities in the program clock reference time stamp sequence may occur for a variety of reasons such a program (channel) change, as described above.

Since the decoder's internal “recovered” system time clock suddenly has a new time base, audio and video packets within the decoder pipeline containing decoding and presentation time stamps referring to the previous time base may exhibit large offsets between the program clock reference time stamps (and therefore the internal system time clock time) and the decoding and presentation time stamps, including decoding and presentation time stamps which are in the past with respect to a current internal system time clock time. Moreover, depending upon the amount of buffering employed, several time base discontinuities in the program clock reference time stamp sequence within a short time period may produce a number of different time bases within the decoder system.

There are a variety of alternatives for handling time base discrepancies resulting from discontinuities in the program clock reference time stamp sequence. A new software clock may be introduced into the decoder with each discontinuity, maintaining a consistent association between the new clock signal and the relevant program clock reference time stamp sequence. However, such a solution would not be easy to implement within a software decoder in which the clock is an attribute of a component instance, not an attribute of a packet in the manner of a presentation time stamp. Moreover, handling multiple clocks is more complicated than a single clock per broadcast stream being decoded.

Another alternative involves switching the decoder's internal system time clock to the new time base only after all packets referring to the “old” program clock reference time base have been decoded and presented. However this requires accurate determination of the time at which all packets with decoding and presentation time stamps referring to the old time base have been consumed, and also a specific mechanism to signal the boundary between the “old” and “new” time within the streaming path (e.g., a special packet). While this may not be difficult to implement, every component within the decoder would require modification to propagate this information at all outputs. Additionally, there may be situations in which both the old and new clock values are concurrently required, such as when packets with a presentation time stamp referring to the old time base are being rendered while packets with a decoding time stamp referring to the new time base are simultaneously being decoded upstream.

Yet another alternative is to switch, upon detecting a program clock reference discontinuity, to a free running internal system time clock until all packets with decoding and presentation time stamps referring to the prior time base are consumed, presenting frames at the frame rate while in free running mode. This suffers from the same problems regarding tracking packet consumption and time base boundaries described above, as well as creating a discontinuity of at least the duration of presentation data buffered before receipt by the decoder.

In the present invention, the internal system time clock 201 within decoder 200 (the design employed for either or both of decoders 104-105 in FIG. 1) is synchronized in frequency to the received program clock reference time stamps, but not in value. That is, the internal system time clock 201, while incrementing at the same rate as received program clock reference time stamps, does not lock to the values of the received program clock reference time stamps and may therefore present a different time.

To synchronize decoded audio and video content, demultiplexer 202, which separates audio and video packets and the program clock reference signal from the received broadcast stream, modifies the decoding and presentation time stamps within received audio and video packets prior to forwarding such packets to the audio and video decoders 203-204. The decoding and presentation time stamps within received audio and video packets are replaced by an offset equal to at least the difference between the program clock reference value and the internal system time clock time.

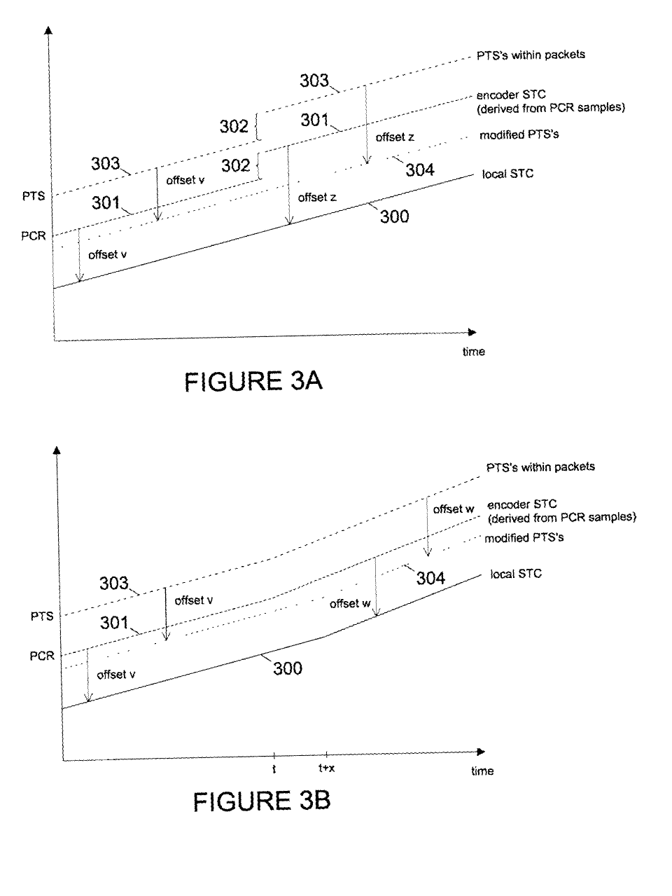

FIG. 3A is a plot illustrating the relationship of the program clock reference signal, the internal system time clock, and modified presentation time stamps within a robust MPEG-2 decoder according to one embodiment of the present invention. While only presentation time stamps are depicted for clarity, those skilled in the art will recognize that the same relationship applies to received and modified decoding time stamps within audio and video packets, but with different offset values.

FIG. 3A illustrates the change in the value or time (vertical axis) of the various clock references and time stamps shown as a function of time (horizontal axis). As shown, the internal system time clock time 300 increases at the same rate as the encoder system time clock time 301, as derived from the program clock reference time stamps within the broadcast stream, but has an independent value. Accordingly, when a time base discontinuity 302 occurs in the program clock reference time stamp sequence 301, internal system time clock time 300 continues to change at the same frequency as the program clock reference time stamps 301, but does not experience the same discontinuity in value (time) and instead continues increasing monotonically.

Presentation time stamps 303 within the received audio and video packets, which are offsets from the encoder system time clock, will reflect the time base discontinuity 302 occurring within the program clock reference time stamp sequence 301. In order to avoid invalidating audio and video packets as a result of the jump in the presentation time stamp sequence 303, the presentation time stamps within the audio and video packets are replaced with modified presentation time stamps prior to forwarding those packets to the audio and video decoder pipelines. The received presentation time stamps 303 are replaced by an offset equal to at least the difference between the program clock reference value 301 and the internal system time clock time 300.

Whatever initial offset value v exists between the program clock reference value 301 and the internal system time clock time 300 is employed for the modified presentation time stamp values 304 for as long as that offset v continues to persist between the program clock reference value 301 and the internal system time clock time 300. When a time base discontinuity 302 occurs in the program clock reference time stamp sequence 301, producing a different offset value z between the program clock reference value 301 and the internal system time clock time 300, the received presentation time stamps 303 within subsequently received audio and video packets are simply replaced by the new offset z. The modified presentation time stamp sequence 304 thus does not experience the time base discontinuity 302 seen in the received presentation time stamp sequence 303, but instead continues increasing monotonically along with the internal system time clock time 300.

It should be noted that while FIG. 3 depicts negative values for offsets v and z, positive or zero offset values may alternatively be employed. Moreover, the offset should be at least the difference between the program clock reference time stamp and the current system time clock time; the offset may optionally include an additional adjustment for stochastic delay for sending (buffering) and processing packets.

Referring back to FIG. 2, within one specific implementation of decoder 200 in the exemplary embodiment of FIG. 2, only demultiplexer 202 (and the counter 205 therein) are implemented in hardware, with the remainder of the decoder 200 implemented in software. Demultiplexer 202 sets an initial time value for and starts internal system time clock 201 during initialization. Internal system time clock 201 generates a 27 MHz clock signal, the time and frequency of the clock may be adapted while the clock is running, although the time value of the clock is not modified during playback of a digital audio/video steam in the present invention.

When a packet within the broadcast stream containing a program clock reference time stamp arrives at demultiplexer 202 at time t, the current value cₜ for counter 205, a 13.5 MHz general purpose input/output (GPIO) counter, is sampled and stored with the program clock reference time stamp PCRₜ to allow reliable comparison by frequency control unit 206 after some non-constant software delay dt.

At the time of comparison, a “current” program clock reference time stamp value PCR′, representing a projection of what the current value of the program clock reference ought to be, may be derived by frequency control unit 206 from the stored program clock reference time stamp PCRₜ, the stored counter value cₜ, and a current value c_{t+dt} for counter 205 by:

PCR′=PCR_{t+dt}=PCRₜ+r*2*(c_{t+dt}−cₜ),

where r is the ratio between the recovered encoder system time clock frequency and a base frequency of 27 MHz for the internal system time clock 201, which may be set to one for the exemplary embodiment without introducing any significant error.

Frequency control unit 206 also samples the time STC from internal system time clock 201 and utilizes sequential samples together with corresponding computed program clock reference time stamps, after applying an averaging filter to the resulting sequence of calculated frequencies and discarding incorrect values, to calculate a frequency f for internal system time clock 201 by:

f=27 MHz*(PCRₙ−PCRₙ₋₁)/(STCₙ−STCₙ₋).

The clock signals for audio and video presentation are generated using direct digital synthesizers (DDS) 206a-206b which output a frequency proportional to a control signal received from phase control units 207a-207b and generated based on the time from internal system time clock 201 and the presentation time stamps received from audio and video decoders 203-204. Frequency control unit 206 receives a measurement of error, the difference between the presentation time stamp and the system time clock time (PTSₙ−STCₙ), as an input and drives that error to zero.

FIG. 3B is a plot illustrating the internal system time clock frequency tracks a frequency reflected by program clock reference time stamps within a robust MPEG-2 decoder according to one embodiment of the present invention. Once again only presentation time stamps are depicted for clarity, although those skilled in the art will recognize that decoding time stamps will exhibit similar behavior, but with different offset values.

FIG. 3B illustrates the change in the value or time (vertical axis) of the various clock references and time stamps shown as a function of time (horizontal axis). As shown, the encoder system time clock may undergo frequency changes, as reflected by the program clock reference time stamps 301 within the broadcast stream. If the program clock reference time stamp sequence 301 (and the received presentation time stamp sequence 303) reflects a frequency change at time t, the frequency of the internal system time clock signal 301 is changed, although not abruptly. By driving the presentation time error measure to zero, the frequency control loop (which includes frequency control unit 206 in FIG. 2) will ensure that the frequency of the internal system time clock 300 will match the new frequency at some point in time t+x, although the offset between the internal system time clock time 300 and the program clock reference time stamps 301 may change. The frequency of modified presentation time stamps 304 will also change with the new offset but will continue increasing monotonically.

Referring once again to FIG. 2, one disadvantage of modifying the decoding and presentation time stamps within audio/video packets is that the modification must be consistent throughout the whole receiver system, which means that other program elementary stream (PES) decoders which receive decoding and presentation time stamps need to calculate the correct clock value in order to make a valid comparison. Demultiplezer 202 therefore publicizes the offsets replacing the decoding and presentation time stamps, which are needed to calculate the correct clock value.

Modification of decoding and presentation time stamps in accordance with the present invention allows time base discontinuity management to be centralized in the demultiplexer 202 where all decoding and presentation time stamps are extracted and in the phase lock loop where the discontinuity is detected. No audio or video decoder 203204 or renderer need manage this special case. Several consecutive time base discontinuities occurring close to each other may also be properly managed. As long as the offsets replacing the decoding and presentation time stamps are stored, a platform application programming interface (API) may be exposed to allow applications or middleware access to the real broadcast system time clock value.

In the present invention, the audio and video decoders are unaware of the modification of decoding and presentation time stamps, and simply present the audio and video frames by comparing the modified decoding and presentation time stamps to samples of the current internal system time clock time. As a result, realization of the audio and video decoder algorithm is simple since no heuristics are need to handle discontinuities. The data and associated time stamps within the decoder pipeline between the demultiplexer and the audio and video decoder outputs remain valid even when the demultiplexer encounters a time base discontinuity. In other words, decoding remains fast, seamless and uninterrupted across program (channel) and other time base changes. Because time stamps derived from an “old” time base refer to a continuously increasing system time clock, the decoder is not forced to skip or repeat frames.

In the present invention, the demultiplexer can also adjust for stochastic delays in processing and buffering along the audio and video paths in a manner transparent to the audio and video decoders by simply adding an additional offset to the decoding and presentation times. Video and audio buffers may be sized and managed by one central demultiplexer preventing underflow or overflow by controlling the offset, and thus accommodating the demultiplexer to decoder delay.

It is important to note that while the present invention has been described in the context of a fully functional receiver and MPEG-2 decoder, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A decoder comprising:
an internal system time clock having a frequency set by reference to a program clock reference signal within an audio/video broadcast stream but having a time independent of a value of the program clock reference signal; and
a demultiplexer extracting audio and video packets from the broadcast stream and modifying decoding and presentation time stamps within the audio and video packets utilizing at least an offset between the program clock reference signal value and the internal system time clock time.

2. The decoder as set forth in claim 1 wherein the offset automatically changes with changes to the program clock reference signal value.

3. The decoder as set forth in claim 2 wherein the modified decoding and presentation time stamps increase monotonically despite discontinuities in a sequence for the program clock reference signal value.

4. The decoder as set forth in claim 1 further comprising:
a frequency control unit receiving the program clock reference signal from the broadcast stream and setting a frequency for the internal system time clock based upon the program clock reference signal value without altering the time for the internal system time clock.

5. The decoder as set forth in claim 1 further comprising:
audio and video decoders each receiving the audio and video packets, respectively, containing the modified decoding and presentation time stamps from the demultiplexer and employing the internal system time clock time and the modified decoding and presentation time stamps within the audio and video packets to control rendering of content within the audio and video packets.

6. The decoder as set forth in claim 1 wherein the decoding and presentation time stamps as received within the audio and video packets are replaced with the offset between the program clock reference signal value and the internal system time clock time.

7. The decoder as set forth in claim 1 wherein the decoding and presentation time stamps as received within the audio and video packets are replaced with the offset between the program clock reference signal value and the internal system time clock time plus a value for processing and buffering delays.

8. A video receiver comprising:
an input for receiving an audio/video broadcast stream;
a video display and audio system, or one or more connections to a video display and audio system, for playback of audio and video content decoded from the audio/video broadcast stream; and
a decoder decoding the audio and video content from the audio/video broadcast stream for playback, the decoder comprising:
an internal system time clock having a frequency set by reference to a program clock reference signal within an audio/video broadcast stream but having a time independent of a value of the program clock reference signal; and
a demultiplexer extracting audio and video packets from the broadcast stream and modifying decoding and presentation time stamps within the audio and video packets utilizing at least an offset between the program clock reference signal value and the internal system time clock time.

9. The video receiver as set forth in claim 8 wherein the offset automatically changes with changes to the program clock reference signal value.

10. The video receiver as set forth in claim 9 wherein the modified decoding and presentation time stamps increase monotonically despite discontinuities in a sequence for the program clock reference signal value.

11. The video receiver as set forth in claim 8 wherein the decoder further comprises:
a frequency control unit receiving the program clock reference signal from the broadcast stream and setting a frequency for the internal system time clock based upon the program clock reference signal value without altering the time for the internal system time clock.

12. The video receiver as set forth in claim 8 wherein the decoder further comprises:
audio and video decoders each receiving the audio and video packets, respectively, containing the modified decoding and presentation time stamps from the demultiplexer and employing the internal system time clock time and the modified decoding and presentation time stamps within the audio and video packets to control rendering of content within the audio and video packets.

13. The video receiver as set forth in claim 8 wherein the decoding and presentation time stamps as received within the audio and video packets are replaced with the offset between the program clock reference signal value and the internal system time clock time.

14. The video receiver as set forth in claim 8 wherein the decoding and presentation time stamps as received within the audio and video packets are replaced with the offset between the program clock reference signal value and the internal system time clock time plus a value for processing and buffering delays.

15. A method of decoding an audio/video broadcast stream comprising:
setting a frequency for an internal system time clock by reference to a program clock reference signal within an audio/video broadcast stream while maintaining a time for the internal system time clock independent of a value of the program clock reference signal; and
extracting audio and video packets from the broadcast stream; and
modifying decoding and presentation time stamps within the audio and video packets utilizing at least an offset between the program clock reference signal value and the internal system time clock time.

16. The method as set forth in claim 15 further comprising:
automatically changing the modification to the decoding and presentation time stamps within the audio and video packets with changes to the program clock reference signal value.

17. The method as set forth in claim 16 further comprising:
increasing the modified decoding and presentation time stamps monotonically despite discontinuities in a sequence for the program clock reference signal value.

18. The method as set forth in claim 15 further comprising:
receiving the program clock reference signal from the broadcast stream; and
setting a frequency for the internal system time clock based upon the program clock reference signal value without altering the time for the internal system time clock.

19. The method as set forth in claim 15 further comprising:
receiving the audio and video packets containing the modified decoding and presentation time stamps at audio and video decoders, respectively; and
employing the internal system time clock time and the modified decoding and presentation time stamps within the audio and video packets to control rendering of content within the audio and video packets by the audio and video decoders.

20. The method as set forth in claim 15 wherein the step of modifying decoding and presentation time stamps within the audio and video packets utilizing at least an offset between the program clock reference signal value and the internal system time clock time further comprises one of:
replacing the decoding and presentation time stamps as received within the audio and video packets with the offset between the program clock reference signal value and the internal system time clock time; and
replacing the decoding and presentation time stamps as received within the audio and video packets with the offset between the program clock reference signal value and the internal system time clock time plus a value for processing and buffering delays.
